(19) United States
(12) Patent Application Publication
(10) Pub. No.: US 2008/0243980 A1
(43) Pub. Date: Oct. 2, 2008

(54) Coupling Simulations With Filtering

(75) Inventors: Daniela K. Busse, San Francisco, CA (US); Ramshankar Venkatasubramanian, Santa Clara, CA (US); Kevin Wang, Shanghai (CN)

Correspondence Address: FISH & RICHARDSON, P.C., PO BOX 1022, MINNEAPOLIS, MN, 55440-1022, US

(73) Assignee: SAP AG

(21) Appl. No.: 11/694,048

(22) Filed: Mar. 30, 2007

(51) Int. Cl. G06F 17/17

(52) U.S. Cl. 708/313

(57) ABSTRACT

Systems, techniques, and machine-readable instructions for coupling simulations with filtering. In one aspect, a method is for coupling simulations with filtering of data. The method includes generating a first visual rendition of a first collection of display data and a second visual rendition of a second collection of display data, receiving user input changing a variable rendered in the second visual rendition, and representing an impact of the change to the variable on the first visual rendition of the first collection of display data. The second collection of display data is a product of filtering the first collection of display data.

### BACKGROUND

This disclosure relates to coupling simulations with filtering.

A simulation attempts to model the behavior of a system. Simulations can be performed using one or more data processing devices that perform operations in accordance with the logic of a set of machine-readable instructions. The logic of such instructions can allow a user to simulate changes to values of variables and use the simulated changes to generate a prediction or other description of the behavior of the system.

Filtering a set of data redacts the information content of a set of data to yield a collection of data that satisfies one or more criteria. For example, filtering can yield a collection of data that have properties or relations designated by one or more predicates. Filtering can be performed using one or more data processing devices performing operations in accordance with the logic of a set of machine-readable instructions. Filtering can be used in a data pipeline to process an input data stream into a relatively smaller output data stream in accordance with the one or more predicates.

### SUMMARY

The present disclosure describes systems, techniques, and machine-readable instructions for coupling simulations with filtering. In one aspect, a method is for coupling simulations with filtering of data. The method includes generating a first visual rendition of a first collection of display data and a second visual rendition of a second collection of display data, receiving user input changing a variable rendered in the second visual rendition, and representing an impact of the change to the variable on the first visual rendition of the first collection of display data. The second collection of display data is a product of filtering the first collection of display data.

This and other aspects can include one or more of the following features. The impact of the change can be represented without receiving user input indicating that the impact is to be represented. A third visual rendition of a third collection of display data can be generated and an impact of the change to the variable on the third visual rendition of the third collection of display data can be represented. The first collection of display data can be a product of filtering the third collection of display data.

Representing the impact of the change can include amending the first visual rendition of the first collection of display data and/or generating a second copy of the first visual rendition of the first collection of display data. The first visual rendition of the first collection of display data can be generated by graphing at least a portion of the first collection of display data. The second visual rendition of the second collection of display data can be generated by representing at least a portion of the second collection of display data in a table. Receiving the user input can include receiving user interaction with the second visual rendition of the second collection of display data. For example, the user interaction can be a user edit of an entry in a table.

In another aspect, a system includes filter logic to filter collections of data to produce filtered data having properties or relations designated by one or more predicates, visual display logic to render a first visual display of a first collection of display data and a second visual display of a second collection of display data on a display screen for a human user, interaction logic to receive a change to a value in the second collection of display data from the human user, and simulation logic to update the first visual display to reflect the change. The second collection of display data can be a product of filtering the first collection of display data.

This and other aspects can include one or more of the following features. The system can also include a collection of source data. The first collection of display data can be a product of filtering the collection of source data. The collection of source data can be isolated from the first collection of display data and the second collection of display data in that the first collection of display data and the second collection of display data are changed without concomitant changes to the collection of source data.

The visual display logic can also render a third visual display of a third collection of display data. The first collection of display data can be a product of filtering the third collection of display data. The simulation logic can also update the third visual display to reflect the change.

In another aspect, an article can include a machine-readable medium storing instructions operable to cause one or more machines to perform operations. The operations can include receiving a collection of source data, filtering the collection of source data one or more times to generate two or more collections of display data, rendering the two or more collections of display data for a human user on a display screen receiving a simulated change to a value that impacts the renditions of the two or more collections of display data, and rendering, for the human user on the display screen, the impact of the simulated change on the renditions of the two or more collections of display data without concomitantly changing the collection of source data.

This and other aspects can include one or more of the following features. Rendering the impact of the simulated change can include amending the renditions of the two or more collections of display data to reflect the change. The operations can also include logging the simulated change in a change log. The operations can also include editing the change log, and committing the edited change log to the collection of source data.

The operations can also include prompting a user for an indication of whether the simulated change is to be committed to the collection of source data. Receiving the simulated change can include receiving user interaction with a representation of the value in one of the renditions of the collections of display data. The user interaction can be a user edit to an entry in a table. The collection of source data can be enterprise data in a hierarchical arrangement of business objects.

The details of one or more implementations are set forth in the accompanying drawings and the description below. Other features and advantages will be apparent from the description and drawings, and from the claims.

### DESCRIPTION OF DRAWINGS

FIG. 1 is a schematic illustration of a filtering of a data collection that includes a first amount of data.

FIG. 2 is a schematic illustration of a collection of predicates that can be used for the filtering of a data collection.

FIG. 3 is a flow chart of an example of a process in which simulations are coupled with filtering.

FIG. 4 is a schematic representation of an example of a display screen on which filtered source data is rendered.

FIG. 5 is a schematic representation of an example of a display screen on which filtered source data and twice-filtered data are rendered.

FIGS. 6A and 6B are schematic representations of examples of display screens on which simulations are coupled with filtering.

FIG. 7 is a flow chart of another example of process in which simulations are coupled with filtering.

FIG. 8 is a schematic representation of an example of a display screen on which filtered source data, twice-filtered data, and thrice-filtered data are rendered.

FIG. 9 is a schematic representation of an example of a display screen on which simulations are coupled with filtering.

FIG. 10 is a schematic representation of an example of a display screen on which filtered source data, twice-filtered data, and thrice-filtered data are rendered.

FIG. 11 is a schematic representation of an example of a display screen on which simulations are coupled with filtering

FIG. 12 is a flow chart of an example of a process that can be used with the coupling of simulations with filtering.

Like reference symbols in the various drawings indicate like elements.

### DETAILED DESCRIPTION

FIG. 1 is a schematic illustration of the filtering of a data collection 105 that includes a first amount of data. Data collection 105 can be a structured set of persistent, machine-readable data, such as a relational database, an object-oriented database, a hierarchical database, or a network database. For example, data collection 105 can be a data table, as shown. As another example, data collection 105 can be a collection of enterprise data that includes a hierarchical arrangement of a collection of business objects that abstract the entities of a business or other enterprise.

Data collection 105 can be represented as a data stream 110 that is filtered by a filter 115 to yield a filtered data stream 120. Filtered data stream 120 does not include the entire information content of data stream 110. Instead, filtered data stream 120 includes some fraction of the information content of data stream 110. For example, filtered data stream 120 can be the fraction of data stream 110 that possesses properties or relations designated by one or more predicates. Filtered data stream 120 can thus be subset of data stream 110 in that all the data in filtered data stream 120 can also be found in data stream 110. The relative amounts of information content in data streams 110, 120 are represented by the relative size of the arrows representing data streams 110, 120.

Filtered data stream 120 can be used in a variety of different data processing activities. For example, filtered data stream 120 can be processed to render at least some of the information content of filtered data stream 120 for a human user on an output device 125. Output device 125 can include one or more visual, auditory, and/or mechanical output devices that renders information for a human user in accordance with the logic of one or more sets of machine-readable instructions. For example, output device 125 can include a computer monitor, a display screen of a personal digital assistant, or the like. Data in filtered data stream 120 can be output in variety of different ways, in accordance with the nature of output device 125. For example, information in filtered data stream 120 can be rendered in a graphical rendition 130 and/or a tabular rendition 135, as discussed further below. The entire information content of filtered data stream 120 need not be rendered in graphical rendition 130 or tabular rendition 135. Instead, graphical rendition 130 or tabular rendition 135 can render a subset of the data of filtered data stream 120 and/or summaries, averages, or other combinations of the information content of filtered data stream 120. The summaries can be prepared, e.g., by performing mathematical operations on the data of filtered data stream 120.

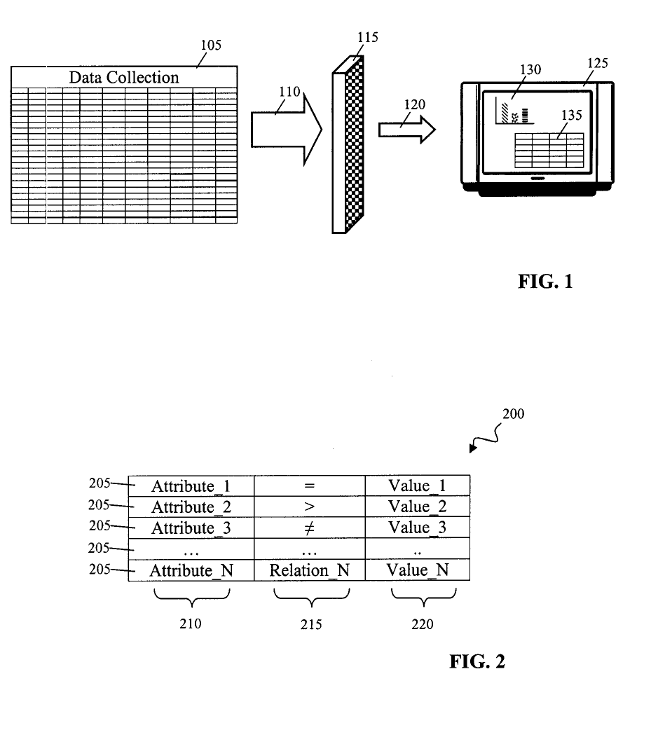

FIG. 2 is a schematic illustration of a collection 200 of predicates 205 that can be used for the filtering of a data collection. Each predicate 205 in collection 200 specifies that an attribute 210 have a relation 215 with one or more values 220. Attributes 210 can specify a portion of a collection of data. For example, attribute 210 can be, e.g., a column in a data table, a field in a record, an entry in an array, an attribute in a data object, or the like. Relation 215 describes the association between an attribute 210 and a value 220. For example, relation 215 can specify that a binary relation exists, such as an ordered relation. Values 220 specify a characteristic, such as a numerical value, string of text, or the like. The predicates 205 in a collection 200 can be used to implement a database query or other filter expression for the filtering of a data collection.

A single filter, such as filter 115 (FIG. 1), can use multiple predicates 205 for the filtering of a data collection. Also, multiple filters with different predicates 205 can be used in series to achieve a comparable filtering of a data collection. Thus, for the sake of convenience, both single filters and multiple filters are referred to herein in the singular.

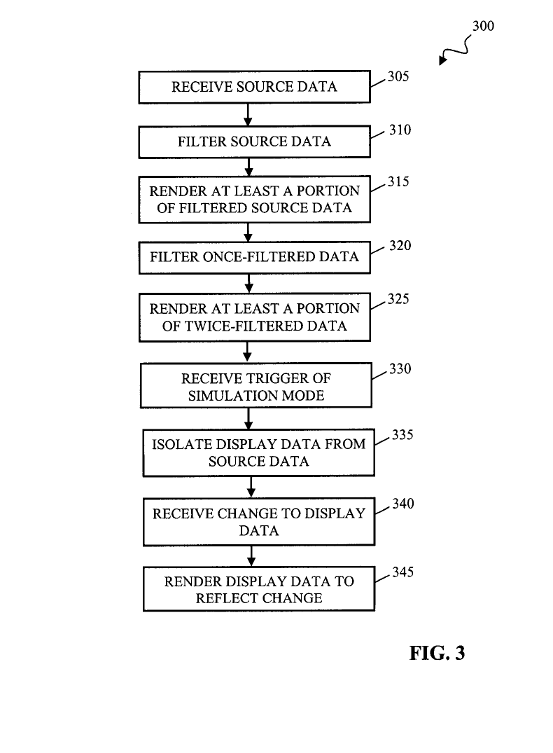

FIG. 3 is a flow chart of a process 300 in which simulations are coupled with filtering. Process 300 can be performed by one or more devices in accordance with the logic of one or more sets of machine-readable instructions. For example, process 300 can be performed by a computer executing software.

The system performing process 300 can receive a collection of source data at 305. The source data can be received from a structured set of persistent, machine-readable data, such as a relational database, an object-oriented database, a hierarchical database, or a network database. For example, source data can be received from a collection of enterprise data that includes a hierarchical arrangement of a collection of business objects that abstract the entities of a business or other enterprise. The source data can also be received after such a set of persistent data has been filtered or otherwise processed.

The system performing process 300 can filter the source data at 310. This filtering can yield a filtered data stream that constitutes the fraction of the information content of the source data stream. The nature of the filtering, such as the specific properties, relations, and/or predicates used in filtering, can be determined based on interaction with a human user. For example, a human user can select a first filter from a collection of predefined filters or a human user can define a new filter by interacting with a filter expression builder or the like.

The system performing process 300 can render at least a portion of the filtered source data at 315. The filtered source data can be rendered in a graphical (e.g., a graph, pie chart, or the like) or text (as a table, a list, a sentence/paragraph, or the like) format. The rendition of the filtered source data can include raw data drawn directly from the source data and/or processed data, such as summaries, averages, or other combinations of raw data.

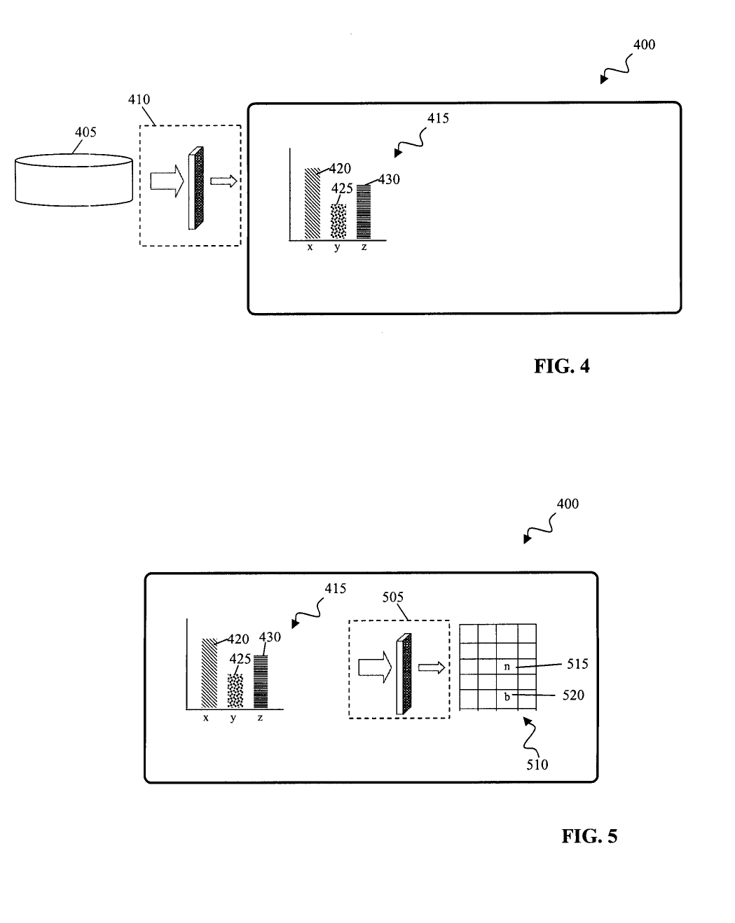

FIG. 4 is a schematic representation of a display screen 400 on which filtered source data is rendered. In particular, source data from a database 405 is filtered at 410 and the filtered source data is rendered in a graph 415. A graph is a diagram that represents the value or variation of a variable relative to the value or variation of one or more other variables. The value or variation of a variable in a graph can be represented using one or more representative elements, such as bars, points, lines, line segments, curves, areas, or the like. For example, in graph 415, a bar representative element 420 represents the value of a variable “x,” a bar representative element 425 represents the value of a variable “y,” and a bar representative element 430 represents the value of a variable “z.”

Returning to FIG. 3, the system performing process 300 can filter the once-filtered data al 320. This second filtering can yield a twice-filtered data stream that constitutes the fraction of the information content of both the source data stream and the filtered source data. The nature of the second filtering, such as the specific properties, relations, and/or predicates used in filtering, can be determined based on interaction with a human user. For example, a human user can select a second filter from a collection of predefined filters or a human user can define a new filter by interacting with a filter expression builder or the like. As another example, a human user can interaction with one or more elements of graph 415 (FIG. 4) to select the second filter, as described in U.S. patent application Ser. No. 11/618,625, filed Dec. 29, 2006 and entitled “Filtering Data,” the contents of which are incorporated herein by reference.

The system performing process 300 can render at least a portion of the twice-filtered data at 325. The twice-filtered data can be rendered in a graphical (e.g., a graph, pie chart, or the like) or text (as a table, a list, a sentence/paragraph, or the like) format. The rendition of the twice-filtered data can include raw data drawn directly from the source data and/or processed data, such as summaries, averages, or other combinations of raw data. The twice-filtered data can be rendered on the same display screen as the filtered source data.

FIG. 5 is a schematic representation of display screen 400 on which filtered source data and twice-filtered data are rendered. In particular, filtered source data is again filtered at 505 and the twice-filtered data is rendered in a table 510. A table includes rows and columns that systematically arrange text information. The information displayed in the rows and columns of a table can be, e.g., a subset of the information in a collection and/or a summary, average, or other combination of the information in a collection. For example, in table 510, a text entry 515 represents that information in the twice-filtered data has the value “n” and text entry 520 represents that other information in the twice-filtered data has the value “b.”

Returning to FIG. 3, the system performing process 300 can receive a trigger of indicating that a simulation mode is to be entered at 330. The trigger can be received from a human user. For example, the trigger can be received from a human user interacting with one or more interactive elements rendered on the same display screen as the filtered source data and the twice-filtered data.

In response to receipt of the simulation mode trigger, the system performing process 300 can isolate some or all of the display data from the source data at 335. The display data is the data that is actually used to render the filtered source data and the twice-filtered data. When the display data is isolated from the source data, changes to the display data can be simulated and a simulation performed without concomitant changes to the source data. For example, when the source data is a set of data stored in a database, changes to the display data can be simulated and used in simulations without the changes being committed to the database.

Display data can be isolated from the source data in a number of different ways. For example, in one implementation, the entirety of the source data can be copied and used in the rendition of the filtered source data and the twice-filtered data during simulations. In another implementation, a fraction of the source data can be copied and used in the rendition of the filtered source data and the twice-filtered data during simulations. For example, the fraction of the source data that remains after the source data has been filtered (i.e., the filtered source data) can be copied and used in the rendition of the filtered source data and the twice-filtered data during simulations.

As yet another example, a change log can be prepared. The change log can collect edits or other simulated changes that are used in the rendition of the filtered source data and the twice-filtered data during simulations, along with information identifying the disposition of the changes in the source data. These edits or other simulated changes in the change log are not initially committed to the source data and hence remain isolated from the source data. Instead, filters can be applied to the source data and the results of filtering modified based on the change log.

Please note that isolating display data from source data does not prevent the filters used to filter source or once-filtered data from being changed, or the renditions of the filtered source or once-filtered data from being amended to reflect such changes. For example, when the entirety of the source data is copied, filters can be changed and applied to the copy of the source data. As another example, when a fraction of the source data is copied, different filters that are limited to the scope of the copied fraction can be applied to the copied fraction. When a different filters is not limited to the scope of the copied fraction, the size of the copied fraction can be changed. As another example, a change log can be prepared and applied to the rendition of the filtered source data and the twice-filtered data although a different filtering is performed on the source data

The system performing process 300 can receive one or more simulated changes to the display data at 340. The simulated changes can be received from a human user, e.g., as a consequence of user interaction with one or more interactive elements rendered on the same display screen as the filtered source data and the twice-filtered data. In some implementations, one or both of the rendition of the filtered source data and the twice-filtered data can themselves be interactive elements that can receive simulated changes.

The system performing process 300 can render the display data to reflect the received simulated change at 345. The renditions reflecting the received simulated change can include changed graphs, edited text, additional elements in graphs, and new text and/or graphs that reflects the impact of the received simulated change. The renditions reflecting the received simulated change thus present the results of a simulation to a human user in a manner that is coupled to filtering.

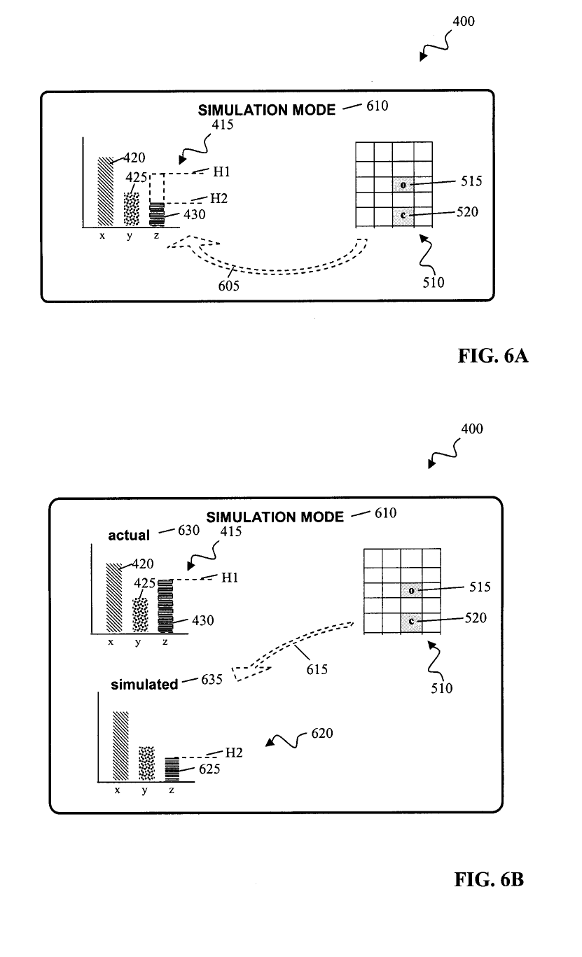

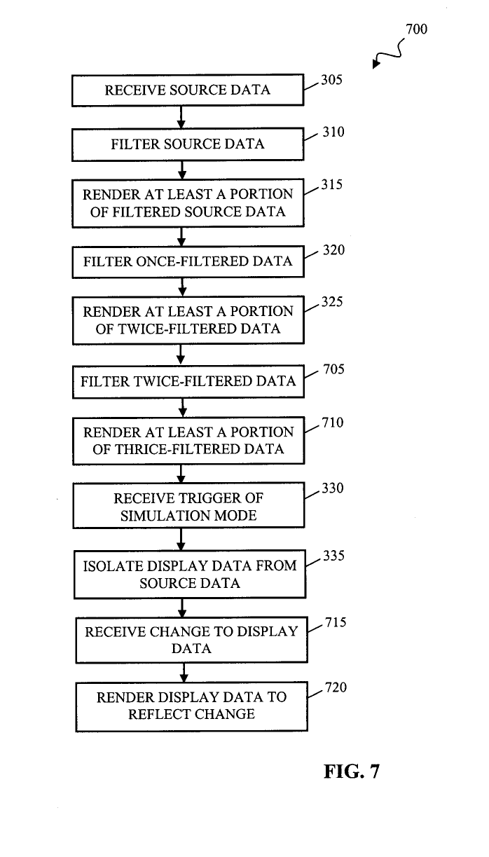

FIG. 6A is a schematic representation of display screen 400 on which simulations are coupled with filtering. As shown, display screen 400 also includes a visual element 610 that indicates that a simulation mode has been entered. Table 510 acts as an interactive element for receiving simulated changes to variables from a human user, although other interactive elements (such as a separate text box widget) are possible. The received simulated changes are used to run simulations, the results of which are presented to the user in display screen 400.

In the illustrated simulation, user interaction with text entry 515 has changed the former value “n” to a different value “o.” Also, user interaction with text entry 520 has changed the former value “b” to a different value “c.” These simulated changes to data variables can be used to run simulations. However, with the display data isolated from the source data, concomitant changes to the source data are not made.

The results of the simulation with the changed data variables can be presented to a user as amendments to graph 415 and table 510. In particular, the simulated changes to the values represented in text entries 515, 520 can also be carried over at 605 to amend graph 415. In the illustrated implementation, the height of bar representative element 430 has been amended from a height H1 to a height H2 to reflect simulated changes to the value of a variable “z” that result from the interaction with text entries 515, 520. The changes to graph 415 can be made automatically, i.e., without receiving input from a user that indicates that the changes to graph 415 are to be made.

FIG. 6B is a schematic representation of display screen 400 on which simulations are coupled with filtering. The simulated changes to the values represented in text entries 515, 520 can be carried over at 615 to create a graph 620. Graph 620 reflects the impact of the simulated changes to the values represented in text entries 515, 520 on the variables “x,” “y,” and “z.” In the illustrated implementation, the height of a bar representative element 625 is set to a height H2, rather than the height H1 which represents the value of a variable “z” in the absence of the simulated changes. Graph 620 can be created automatically, i.e., without receiving input from a user that indicates that graph 620 is to be created.

Display screen 400 also includes a first visual element 630 and a second visual element 635. First visual element 630 indicates that graph 415 represents certain values in the absence of the simulated changes. Second visual element 635 indicates that graph 620 represents those values in the light of the simulated changes.

FIG. 7 is a flow chart of another process 700 in which simulations are coupled with filtering. Process 700 can be performed by one or more devices in accordance with the logic of one or more sets of machine-readable instructions. For example, process 700 can be performed by a computer executing software.

The system performing process 700 can receive a collection of source data at 305, filter the source data at 310, render at least a portion of the filtered source data at 315, filter the once-filtered data at 320, and render at least a portion of the twice-filtered data at 325 as described above (FIG. 3).

The system performing process 700 can also filter the twice-filtered data at 705. This third filtering can yield a thrice-filtered data stream that constitutes the fraction of the information content of both the source data stream, the filtered source data, and the twice filtered data. The nature of the third filtering, such as the specific properties, relations, and/or predicates used in filtering, can be determined based on interaction with a human user. For example, a human user can select a third filter from a collection of predefined filters or a human user can define a new filter by interacting with a filter expression builder or the like. As another example, a human user can interaction with one or more elements of table 510 (FIG. 5) to select the third filter.

The system performing process 700 can render at least a portion of the thrice-filtered data at 710. The thrice-filtered data can be rendered in a graphical (e.g., a graph, pie chart, or the like) or text (as a table, a list, a sentence/paragraph, or the like) format. The rendition of the thrice-filtered data can include raw data drawn directly from the source data and/or processed data, such as summaries, averages, or other combinations of raw data. The thrice-filtered data can be rendered on the same display screen as the filtered source data and the twice-filtered data.

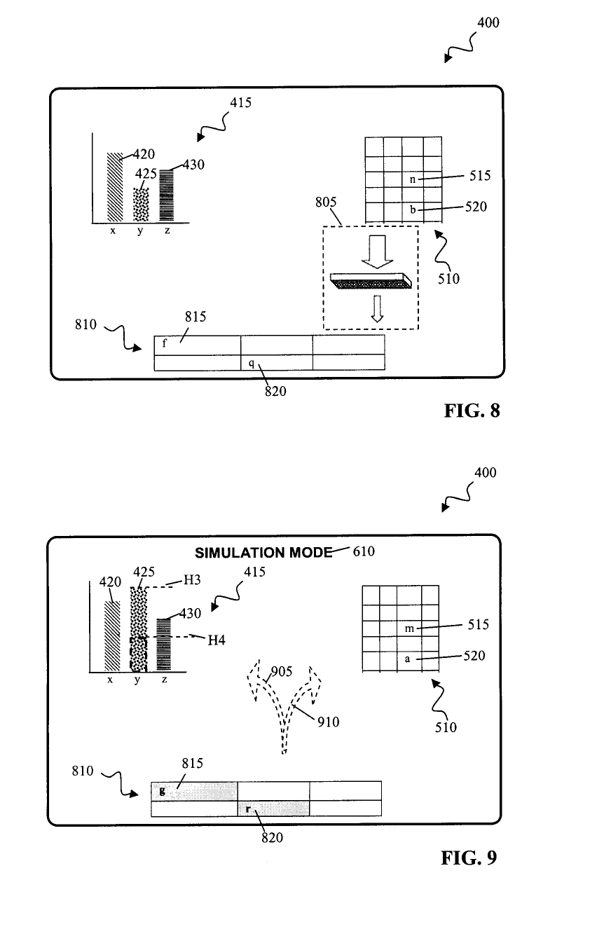

FIG. 8 is a schematic representation of display screen 400 on which filtered source data, twice-filtered data, and thrice-filtered data are rendered. In particular, twice filtered data is again filtered at 805 and the thrice-filtered data is rendered in a table 810. In table 510, a text entry 815 represents that information in the thrice-filtered data has the value “f” and text entry 820 represents that other information in the thrice-filtered data has the value “q.”

Returning to FIG. 7, the system performing process 700 can receive a trigger of indicating that a simulation mode is to be entered at 330 isolate some or all of the display data from the source data at 335, as described above (FIG. 3).

The system performing process 700 can receive one or more simulated changes to the display data at 715. The simulated changes can be received from a human user, e.g., as a consequence of user interaction with one or more interactive elements rendered on the same display screen as the filtered source data, the twice-filtered data, and the thrice-filtered data. In some implementations, one or more of the rendition of the filtered source data, the twice-filtered data, and the thrice-filtered data can themselves be interactive elements that can receive simulated changes.

The system performing process 700 can render portions of the filtered change data, the twice-filtered data, and the thrice-filtered data to reflect the received simulated changes at 720. The renditions reflecting the received simulated changes can include changed graphs, edited text, additional elements in graphs, and new text and/or graphs that reflects the impact of the received simulated changes. The renditions reflecting the received simulated changes thus present the results of a simulation to a human user in a manner that is coupled to filtering.

FIG. 9 is a schematic representation of display screen 400 on which simulations are coupled with filtering. As shown, display screen 400 also includes a visual element 610 that indicates that a simulation mode has been entered. Rendition of thrice-filtered data 810 acts as an interactive element for receiving simulated changes to variables from a human user, although other interactive elements are possible. The received simulated changes are used to run simulations, the results of which are presented to the user in display screen 400.

In the illustrated simulation, user interaction with text entry 815 has changed the former value “f” to a different value “g.” Also, user interaction with text entry 820 has changed the former value “q” to a different value “r.” These simulated changes to data variables can be used to run simulations. However, with the display data isolated from the source data, concomitant changes to the source data are not made.

The results of the simulation with the changed data variables can be presented to a user as amendments to graph 415 and table 510. In particular, the simulated changes to the values represented in text entries 815, 820 can be carried over at 905 to amend graph 415. In the illustrated implementation, the height of bar representative element 425 has been amended from a height H4 to a height H3 to reflect simulated changes to the value of a variable “y” that result from the interaction with text entries 815, 820.

The simulated changes to the values represented in text entries 815, 820 can also be carried over at 910 to amend table 510. In the illustrated implementation, the former value “n” of text entry 515 has been amended to a different value “m” and the former value “b” of text entry 520 has been amended to a different value “a.” The changes to graph 415 and table 510 can be made automatically, i.e., without receiving input from a user that indicates that the changes to graph 415 and table 510 are to be made.

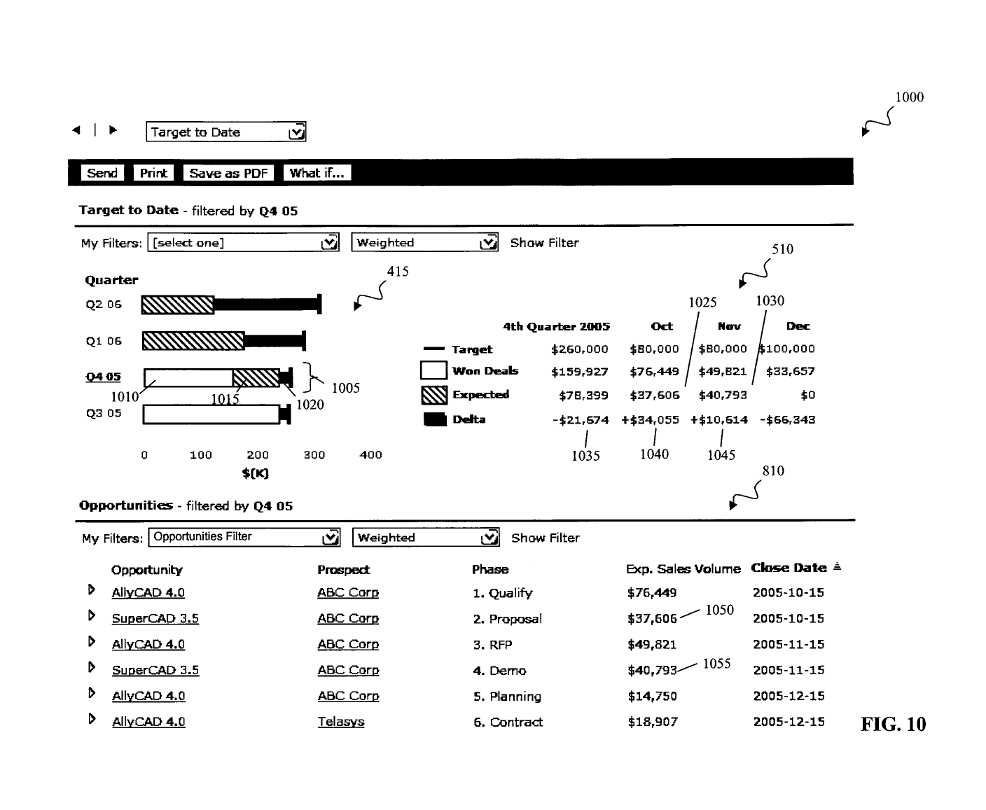

FIG. 10 is a schematic representation of display screen 1000 on which a filtered graph 415, a table 510, and table 810 are displayed.

In graph 415, a bar representative element 1005 represents sales data for the fourth quarter of 2005. In particular, a first portion 1010 represents sales that have been made (i.e., “won deals”) for the fourth quarter of 2005, a second portion 1015 represents sales that are expected to be made (i.e., “expected”) in the fourth quarter of 2005, and a third portion 1020 represents the difference between a sales target and the sum of the sales that have been made and the sales that are expected to be made (i.e., “delta”) in the fourth quarter of 2005.

In table 510, a text entry 1025 represents that $37,606 in sales are expected to be made in October of 2005, a text entry 1030 represents that $40,793 in sales are expected to be made in November of 2005, a text entry 1035 represents that the sum of the sales that have been made and the sales that are expected to be made for the fourth quarter of 2005 is short $21,764 of the sales target, a text entry 1040 represents that the sum of the sales that have been made and the sales that are expected to be made in October of 2005 is above the sales target by $34,055, and a text entry 1045 represents that the sum of the sales that have been made and the sales that are expected to be made in November of 2005 is above the sales target by $10,614.

In table 810, a text entry 1050 represents that a sales opportunity AllyCAD 4.0 with the ABC Corporation in November has an expected sales volume of $37,606, and a text entry 1055 represents that a sales opportunity SuperCAD 3.5 with the ABC Corporation in December has an expected sales volume of $40,793.

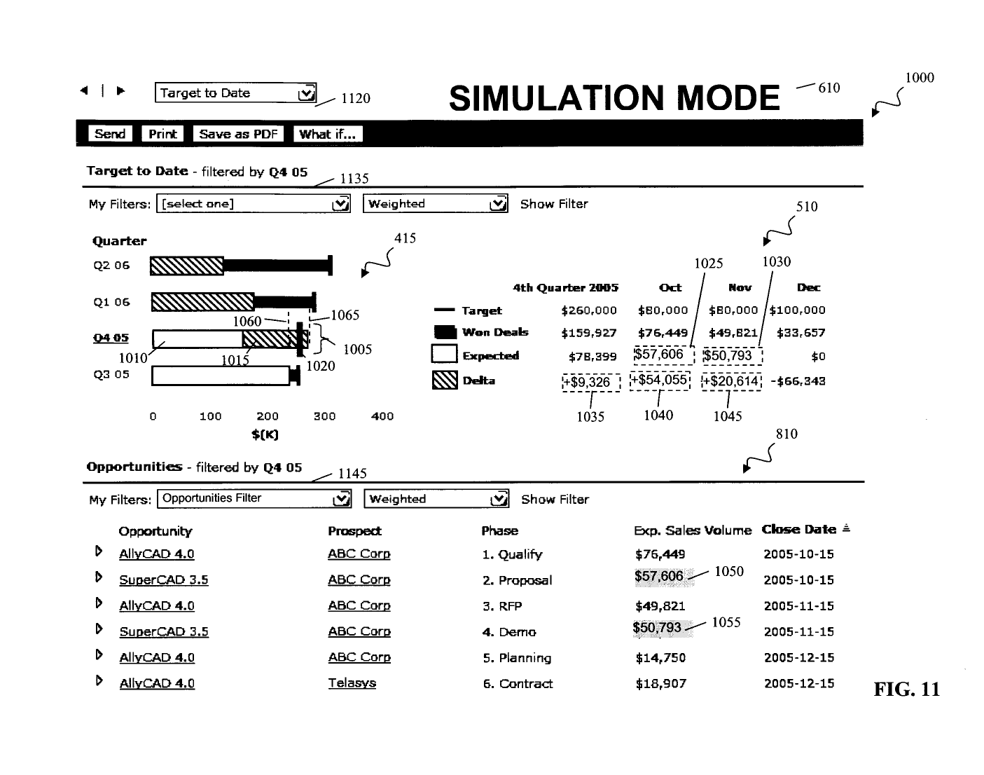

FIG. 11 is a schematic representation of display screen 1000 in which simulations are coupled with filtering. As shown, display screen 1000 also includes a visual element 610 that indicates that a simulation mode has been entered. Table 810 acts as an interactive element for receiving simulated changes to variables from a human user, although other interactive elements (such as a separate text box widget) are possible. The received simulated changes are used to run simulations, the results of which are presented to the user in display screen 1000.

In the illustrated simulation, user interaction with text entry 1050 has changed the former value of $37,606 to a different value of $57,606. Also, user interaction with text entry 1055 has changed the former value of $40,793 to a different value of $50,793. These simulated changes to data variables can be used to run simulations. However, with the display data isolated from the source data, concomitant changes to the source data are not made.

The results of the simulation with the changed data variables can be presented to a user as amendments to graph 415 and table 510. In particular, the simulated changes to the variables represented in text entries 1050, 1055 can be carried over to amend graph 415 and table 510.

In table 510, the values of text entries 1025, 1030, 1035, 1040, 1045 have been amended to reflect the simulated changes to the variables represented in text entries 1050, 1055 made by the user. In particular, the former value of $37,606 of text entry 1025 has been amended to a different value of $57,606, the former value of $40,793 of text entry 1030 has been amended to a different value of $50,793, the former value of short $21,764 of text entry 1035 has been amended to a different value of $9,326 above target, the former value of being $34,055 above target in text entry 1040 has been amended to a different value of being $54,055 above target, and the former value of being $10,614 above target in text entry 1045 has been amended to a different value of being $20,614 above target.

In graph 415, constituent portions 1015, 1020 of bar representative element 1005 have been amended to reflect the simulated changes to the variables represented in text entries 1050, 1055 made by the user. In particular, the end of second portion 1015 has been shifted from a position 1060 to a position 1065, and third portion 1020 has been deleted. The changes to graph 415 and table 510 can be made automatically, i.e., without receiving input from a user that indicates that the changes to graph 415 and table 510 are to be made.

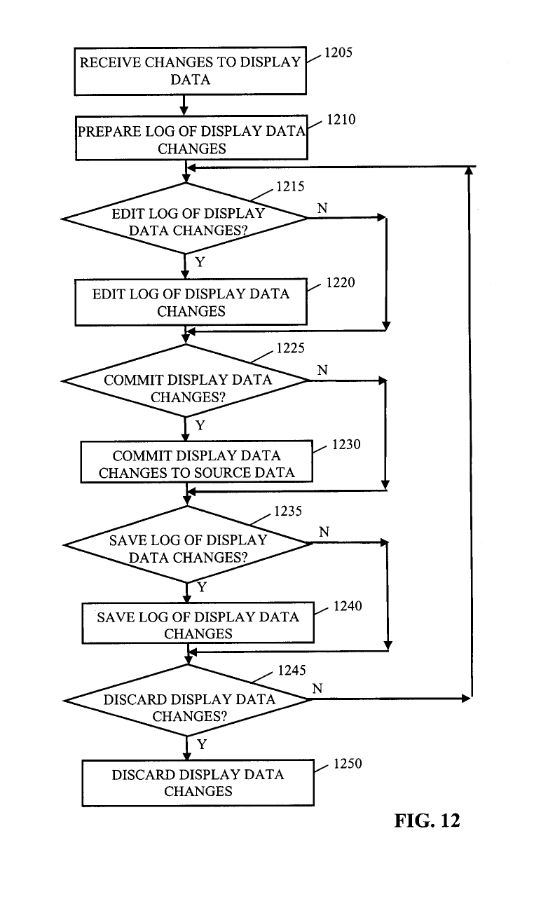

FIG. 12 is a flow chart of a process 1200 that can be used with the coupling of simulations with filtering. Process 1200 can be performed by one or more devices in accordance with the logic of one or more sets of machine-readable instructions. For example, process 1200 can be performed by a computer executing software.

The system performing process 1200 can receive one or more simulated changes to display data at 1205. For example, the simulated changes can be received at 340 in process 300 (FIG. 3). As another example, the simulated changes can be received at 715 in process 700 (FIG. 7).

The system performing process 1200 can prepare a log of the display data simulated changes at 1210. For example, the simulated changes to display data can be recorded serially, as they are received, in conjunction with information identifying the context of the changed data in a collection of source data.

The system performing process 1200 can determine if the log of the display data simulated changes is to be edited at 1215. The determination can be made automatically or in response to user interaction. For example, the system performing process 1200 can apply one or more rules to determine if the log of the display data simulated changes is to be edited. As another example, the system performing process 1200 can prompt a user for an indication whether the user wishes to edit the log of the display data simulated changes.

If the system performing process 1200 determines that the log of the display data simulated changes is to be edited, then the system can edit the log of the display data simulated changes at 1215. The edits can be made automatically or in response to user interaction. For example, syntax or other rules can be applied automatically to edit the display data simulated changes. As another example, an interactive element can be presented to a user and edits to the display data simulated changes can be received. If the system performing process 1200 determines that the log of display data simulated changes is not to be edited, then the system can proceed to 1225.

The system performing process 1200 can determine if the display data simulated changes in the log are to be committed to source data at 1225. The determination can be made automatically or in response to user interaction. For example, the system performing process 1200 can apply one or more rules to determine if the display data simulated changes in the log are to be committed. As another example, the system performing process 1200 can prompt a user for an indication whether the user wishes to commit the display data simulated changes to source data. If the system performing process 1200 determines that display data simulated changes in the log are to be committed, then the system can commit display data simulated changes at 1230. If the system performing process 1200 determines that the display data simulated changes in the log are not to be committed, then the system can proceed to 1235.

The system performing process 1200 can determine if the log of display data changes is to be saved at 1235. The determination can be made automatically or in response to user interaction. For example, the system performing process 1200 can apply one or more rules to determine if the log of display data simulated changes is to be saved. As another example, the system performing process 1200 can prompt a user for an indication whether the user wishes to save the log of display data simulated changes. If the system performing process 1200 determines that the log of display data simulated changes is to be saved, then the system can save the log of display data simulated changes at 1240. If the system performing process 1200 determines that the log of display data changes is not to be saved, then the system can proceed to 1245.

The system performing process 1200 can determine if the log of display data simulated changes is to be discarded at 1245. The determination can be made automatically or in response to user interaction. For example, the system performing process 1200 can apply one or more rules to determine if the log of display data simulated changes is to be discarded. As another example, the system performing process 1200 can prompt a user for an indication whether the user wishes to discard the log of display data simulated changes. If the system performing process 1200 determines that the log of display data simulated changes is to be discarded, then the system can discard the log of display data simulated changes at 1250. If the system performing process 1200 determines that the log of display data simulated changes is not to be discarded, then the system can return to 1215 to determine if the log of display data simulated changes is to be edited.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A number of implementations have been described. Nevertheless, it will be understood that various modifications may be made. For example, steps can be performed in different orders and/or omitted and meaningful results nevertheless achieved. Visual elements can be rearranged, deleted, or added to the illustrated display screens and yet meaningful results nevertheless achieved. Accordingly, other implementations are within the scope of the following claims.

What is claimed is:

1. A method for coupling simulations with filtering of data, comprising:
generating a first visual rendition of a first collection of display data and a second visual rendition of a second collection of display data, wherein the second collection of display data is a product of filtering the first collection of display data;
receiving user input changing a variable rendered in the second visual rendition; and
representing an impact of the change to the variable on the first visual rendition of the first collection of display data.

2. The method of claim 1, wherein the impact of the change is represented without receiving user input indicating that the impact is to be represented.

3. The method of claim 1, further comprising:
generating a third visual rendition of a third collection of display data, wherein the first collection of display data is a product of filtering the third collection of display data; and
representing an impact of the change to the variable on the third visual rendition of the third collection of display data.

4. The method of claim 1, wherein representing the impact of the change comprises amending the first visual rendition of the first collection of display data.

5. The method of claim 1, wherein representing the impact of the change comprises generating a second copy of the first visual rendition of the first collection of display data.

6. The method of claim 1, wherein:
generating the first visual rendition of the first collection of display data comprises graphing at least a portion of the first collection of display data; and
generating the second visual rendition of the second collection of display data comprises representing at least a portion of the second collection of display data in a table.

7. The method of claim 1, wherein receiving the user input comprises receiving user interaction with the second visual rendition of the second collection of display data.

8. The method of claim 7, wherein receiving the user interaction comprises receiving a user edit of an entry in a table.

9. A system comprising:
filter logic to filter collections of data to produce filtered data having properties or relations designated by one or more predicates;
visual display logic to render a first visual display of a first collection of display data and a second visual display of a second collection of display data on a display screen for a human user, wherein the second collection of display data is a product of filtering the first collection of display data;
interaction logic to receive a change to a value in the second collection of display data from the human user; and
simulation logic to update the first visual display to reflect the change.

10. The system of claim 9, further comprising a collection of source data, wherein the first collection of display data is a product of filtering the collection of source data.

11. The system of claim 10, wherein the collection of source data is isolated from the first collection of display data and the second collection of display data in that the first collection of display data and the second collection of display data are changed without concomitant changes to the collection of source data.

12. The system of claim 9, wherein the visual display logic is also to render a third visual display of a third collection of display data, wherein the first collection of display data is a product of filtering the third collection of display data.

13. The system of claim 12, wherein the simulation logic is also to update the third visual display to reflect the change.

14. The system of claim 9, wherein the filter logic, the visual display logic, the interaction logic, and the simulation logic comprise machine-readable instructions tangibly embodied in one or more machine-readable media.

15. An article comprising one or more machine-readable media storing instructions operable to cause one or more machines to perform operations comprising:
receiving a collection of source data;
filtering the collection of source data one or more times to generate two or more collections of display data;
rendering the two or more collections of display data for a human user on a display screen;
receiving a simulated change to a value that impacts the renditions of the two or more collections of display data; and
rendering, for the human user on the display screen, the impact of the simulated change on the renditions of the two or more collections of display data without concomitantly changing the collection of source data.

16. The article of claim 15, wherein rendering the impact of the simulated change comprises amending the renditions of the two or more collections of display data to reflect the change.

17. The article of claim 15, wherein the operations further comprise logging the simulated change in a change log.

18. The article of claim 17, wherein the operations further comprise:
editing the change log; and
committing the edited change log to the collection of source data.

19. The article of claim 15, wherein the operations further comprise prompting a user for an indication of whether the simulated change is to be committed to the collection of source data.

20. The article of claim 15, wherein receiving the simulated change comprises receiving user interaction with a representation of the value in one of the renditions of the collections of display data.

21. The article of claim 15, wherein receiving user interaction with the representation of the value comprises receiving user edit to an entry in a table.

22. The article of claim 15, wherein receiving the collection of source data comprises receiving enterprise data in a hierarchical arrangement of business objects.
